(19) United States
(12) Patent Application Publication
(10) Pub. No.: US 2011/0043309 A1
(43) Pub. Date: Feb. 24, 2011

(54) ELECTROMAGNETICALLY OPERATED MECHANICAL ACTUATOR

(76) Inventors: Daniel Wamala, Budapest (HU); Antal Csordas, Pecs (HU)

Correspondence Address: BIRCH STEWART KOLASCH & BIRCH, PO BOX 747, FALLS CHURCH, VA, 22040-0747, US

(21) Appl. No.: 12/865,103

(22) PCT Filed: Jan. 28, 2009
(86) PCT No.: PCT/HU09/00010

§ 371 Date: Nov. 10, 2010

(30) Foreign Application Priority Data
Jan. 29, 2008 (HU) P0800054

(51) Int. Cl. H01F 7/08

(52) U.S. Cl. 335/260

(57) ABSTRACT

The invention is an electromagnetically operated mechanical actuator that comprises a first magnetic element (4) applied for generating magnetic field, a second magnetic element (8) consisting of a supporting element fitted with an electromagnetic energizing element, a guiding element (1) providing that the second magnetic element (8) may be moved along a given linear path relative to the first magnetic element (4), and a ferrofluid disposed in the interior of the guiding element (1) such that the ferroflud at least partially surrounds the supporting element. The actuator has electrically controlled latching means adapted for stopping and securing the second magnetic element (8) in an arbitrary linear displacement position relative to the first magnetic element (4). The latching means is an electrically controlled valve (7) adapted for allowing or stopping gas flow in the gas-filled region.

The object of the invention is an electromagnetically operated mechanical actuator that comprises a first magnetic element applied for generating magnetic field, a second magnetic element movable relative to the first magnetic element and consisting of a supporting element fitted with an electromagnetic energizing element (voice coil), a guiding element providing that the second magnetic element may be moved along a given linear path relative to the first magnetic element, and a ferrofluid disposed in the interior of the guiding element, and a sealed gas-filled region, a gas space is provided being in communication with the ferrofluid.

Various magnetic and electromagnetic arrangements are known for generating linear displacement, for instance for producing oscillating motion. Utilized as actuators, such arrangements are able to produce various mechanical or acoustic effects. An exemplary type of such actuators are loudspeakers, but all devices producing linear displacement of a specific amount at some physical portion of an arrangement can be regarded as actuators in the wider sense of the term. For instance, the operating elements of robotic arms are also actuators.

A problem with known actuator devices is that they are either not capable of producing static force at a given displacement position for a prolonged period of time or they require that a high amount of energy is fed into the device for continuous static force production.

Another known feature in the field of electromagnetic actuators is the utilization of ferrofluids that are usually applied for filling air gaps of electromagnetic devices. Advantages of ferrofluids include intensifying the magnetic effect, decreasing friction and acting as a coolant (the latter two can also be achieved by oil).

The objective of the invention has been to provide a solution that is capable of stopping the electromagnetically operated linear actuator at any given point in the displacement range such that a constant static pressing force is provided without there being a need for energy-consuming constant energization that would also produce an undesirable heating effect.

The invention is based on the recognition that electromagnetically operated mechanical actuators, electropneumatic actuators in the above framing are capable to realize the following principle. If the maximum of the heath which can be dissipated during a time unit by the actuator (Thermal Design Power—TDP) is known, this limit can be kept by a PWM (Pulse With Modulated) input signal of appropriate voltage and fill factor to the actuator. In this case, since TDP is proportional to these two parameters, one of them can be lowered to the account of the other. Accordingly either high voltage PWM signal of small filling factor or a low voltage PWM signal of higher filling factor can be applied. In the first case if the position fixing means of the actuator, a valve is opened by the rising edge of the PWM pulse, the actuator is moving in quick pushes and capable for lifting relative big loads, burdens. By closing the valve on the falling edge of the PWM pulse the new position will be fixed. The method can be repeated in subsequent PWM periods. In this way an actuator is operated by PWM signals and valves, and without any power transmission means big loads can be slowly or small loads can be quickly moved.

In the view of the above the application of ferrofluid or oil—either in itself or complemented by an air-containing enclosure acting as a spring—a controllable latching means may be provided that is capable of producing a constant static force by halting the movement of a known-art linear actuator at a given position or time, and is also capable of unlatching at any time in a controlled manner to let the device return to its dynamic movement range. We have also recognised that the latching means mentioned above may be implemented by closing the flow-through opening of an air-containing enclosure utilizing a controlled valve, where the enclosed air volume acts a spring, or the latching means in some specific cases may also be implemented by other mechanical means, such as for example an assembly of a threaded member and brake shoes applied for restraining the rotation thereof.

The invention described in the introductory paragraph of the present specification is an electromagnetically operated mechanical actuator that has electrically controlled latching means adapted for stopping and securing a second magnetic element in an arbitrary linear displacement position relative to a first magnetic element. The latching means is an electrically controlled valve adapted for allowing or stopping gas flow in the gas-filled region.

The operating principle and specific embodiments of the invention will be described in detail below with reference to the accompanying drawings, where

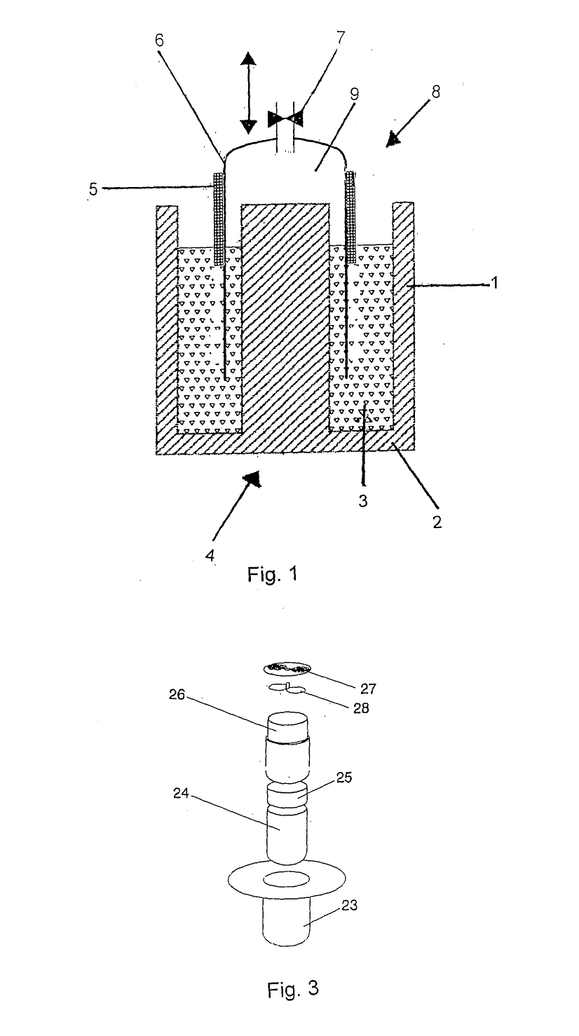

FIG. 1 shows a cross section of a preferred embodiment of the actuator according to the invention;

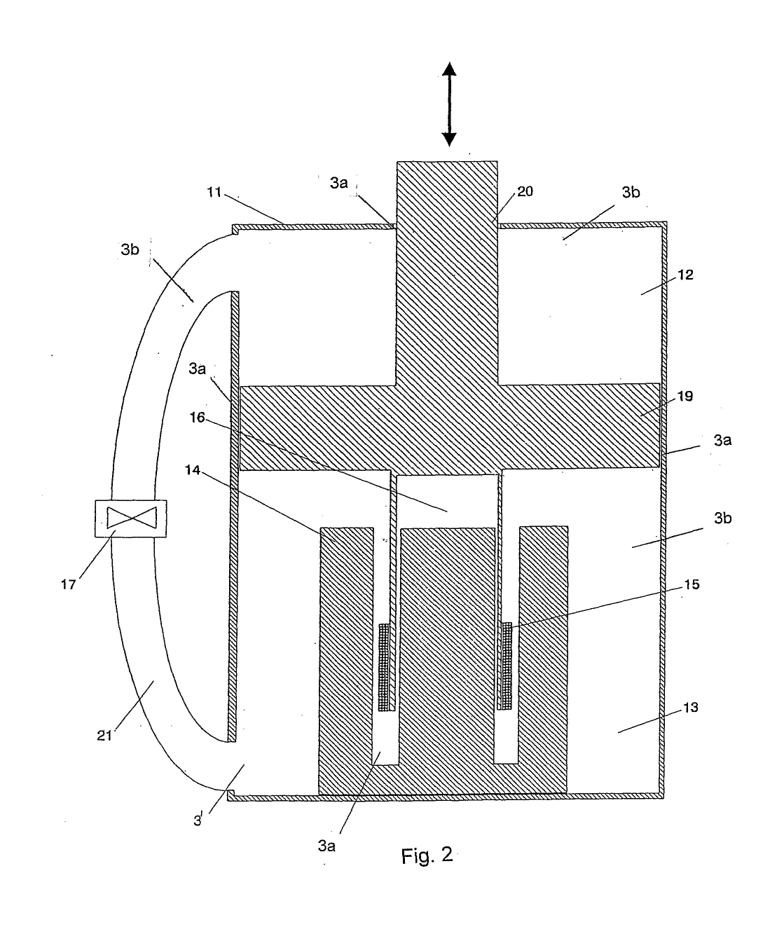

FIG. 2 shows a cross section of another preferred embodiment of the actuator;

FIG. 3 is the cross-sectional view of an embodiment utilizing an air valve as latching means;

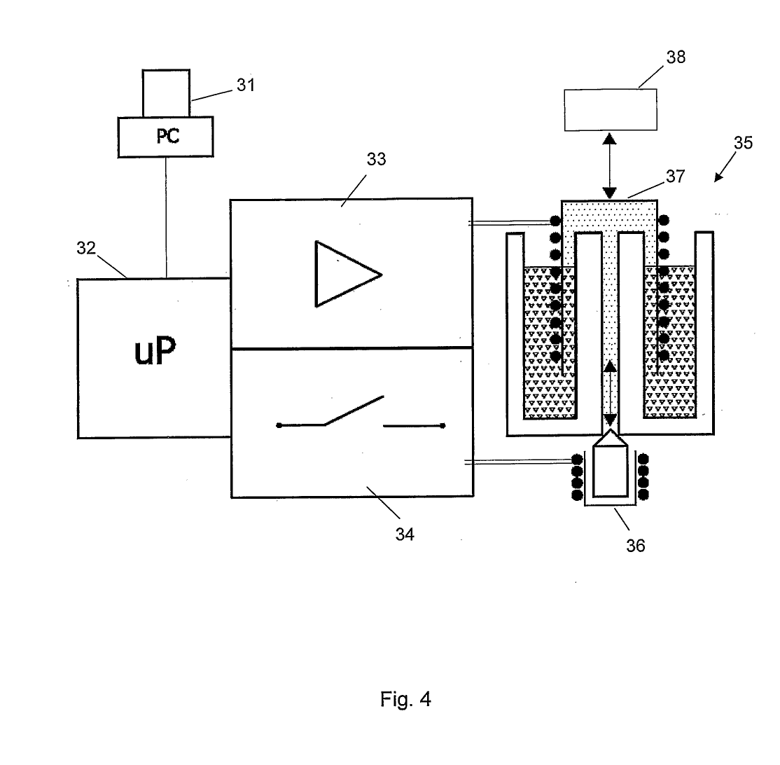

FIG. 4 shows a possible arrangement of controlling a system in which a small actuator is used for lifting relatively big load;

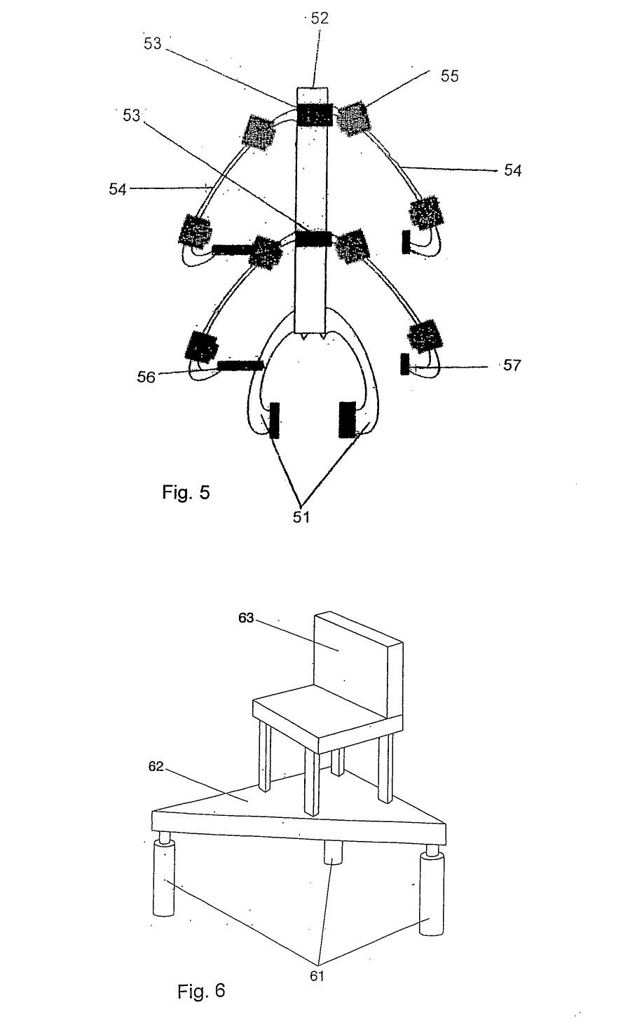

FIG. 5 shows a schematic view of an active vest applying the actuator according to the invention; and

FIG. 6 is a schematic view of an active seat implemented utilizing the actuators according to the invention.

The operating principle of a preferred embodiment of the invention is illustrated by a schematic drawing shown in FIG. 1. As it is shown in the drawing, a coil bobbin 6 is disposed in the guiding element 1, where the guiding element 1 has a closed bottom end 2. The coil bobbin 6 has an electromagnetic energizing element, for instance a coil 5 (this arrangement of elements 5 and 6 is called voice coil in electronics), and is longitudinally displaceable inside the guiding element 1 (in the arrangement shown in the drawing the direction of the displacement is vertical). The guiding element 1 may for instance be implemented as a cylindrical pot magnet (as shown in FIG. 1), of which the central portion may assist in performing the guiding function. The guiding element 1 constitutes a first magnetic element 4 either in itself or cooperating with an additional element disposed fixedly with respect to it. The first magnetic element 4 of FIG. 1 may be implemented utilizing either a permanent magnet or an energized electromagnet. A second magnetic element 8, a voice coil, is constituted by the coil bobbin 6 and an electromagnetically energizable element, the coil 5. The second magnetic element 8 is displaced with respect to the first magnetic element 4 to an extent depending on the energization level of the second magnetic element 8. The coil bobbin 6 is closed at the upper end, with a controlled valve 7 being disposed therein. The bottom portion of the coil bobbin 6 submerges into a ferrofluid 3 partially filling the interior of the guiding element 1. Thereby the interior of the coil bobbin 6 is filled by the ferrofluid 3 at the bottom portion and by air in the upper portion, forming a chamber 9 having a volume varying with the displacement of the second magnetic element 8. In case the controlled valve 7 is open, magnetic forces displacing the voice coil, i.e. the second magnetic element 8, upwards or downwards may be produced by energizing the electromagnetic energizing element thereof. In this case air flows freely through the controlled valve 7 and consequently pressure equalization occurs between the chamber 9 and its exterior. If, however, the controlled valve 7 is closed, air enclosed in the chamber 9 will act as a cushioning means by producing (through air pressure change) a force acting against the displacement causing the volume change of the chamber 7. Thereby a substantially static force is produced, which acts downwards or, upwards on the coil bobbin 6 that has a closed upper end. This static force is present with respect to the resting guiding element 1.

FIG. 2 shows another preferred embodiment, where a housing 11 acts as primer magnetic guiding element. In this arrangement, similarly to the embodiment shown in FIG. 1, the active member is a tubular element closed at both ends, which tubular element is completely filled with medium 3′, which is a flowable fluid like a gas or a liquid, but not ferrofluid. The available space for the medium 3′ is changing during movement. If the medium 3′ is a liquid this can be compensated by known pressure regulator means not disclosed here in details. In case medium 3′ is partially ferrofluid 3a, other filling medium 3b, liquids or gases, may also be utilized for partially filling the tubular element provided that they are immiscible with the ferrofluid 3a. In case the filling medium 3b is a gas, the actuator operates in a manner similar to what was described in relation to FIG. 1, with the difference that while this embodiment is always hermetically sealed, the actuator of FIG. 1 is in thermodynamic equilibrium with air in the exterior and becomes sealed from its exterior only after the air valve is closed (static phase of operation).

The tube shown in FIG. 2 is essentially implemented as a piston cylinder, with a coil bobbin 16 being disposed therein. The coil bobbin 16 is attached to a piston 19 that not only closes the upper end of the coil bobbin 16 but also divides the interior of the housing 11 into separated regions 12, 13 and effectively restrains flow of filling medium 3b between these separated regions. The piston 19 is preferably made of ferromagnetic material, with an also ferromagnetic piston shank 20, passed through the upper end of the housing 11 with liquidtight sealing, provided by ferrofluid 3a, and being connected to the piston 19. The coil bobbin 16 and the coil 15 forming the electromagnetically energizable element collectively constitute a second magnetic element 18, a voice coil. Similarly to the above described embodiment, the first magnetic element 14 is implemented as a pot magnet that is secured to the bottom end of the housing 11. The housing 11 also gets excited by the first magnetic element 14, which results through the sealing feature of ferrofluid 3a being in a magnetic field an effective sealing at the piston shank 20 both at the upper end of the housing 11 and between regions 12, 13. At the bottom and upper end of the cylindrical housing 11 a flow-through conduit 21 is connected thereto, communicating with the interior of the housing 11 through openings. When the piston 19 is displaced, fluid flows between regions 12, 13 through this flow-through conduit 21 to balance pressure. A controlled valve 17, applied for allowing or stopping the balancing flow of fluid, is arranged in the course of the flow-through conduit 21. The piston 19 also prevents the flow of filling medium 3b between the separated regions. When the controlled valve 17 is opened, the second magnetic element 18—together with the piston 19 fixedly connected thereto—may freely move upward or downwards. In case the flow-through conduit 21 is closed by the controlled valve 17, then, due to the pressure difference between regions 12 and 13 or due to its effect combined with electromagnetic energizing, the arrangement becomes capable of producing a static force—relative to the housing 11—that accomplishes the objective of the invention. This embodiment is capable of producing both dynamic and static force, and allows very accurate positioning when the filling medium 3b is a liquid. Because the controlled valve 17 may be implemented as a fluid valve—in contrast to the air valve 7 utilized in the previous embodiment—this solution is more preferable as far as accuracy and structural complexity are concerned.

FIG. 3 shows the arrangement of a conceivable embodiment utilizing an air valve. A magnetic core 24 or an iron core fitted with an electromagnetic coil is disposed in a ferromagnetic housing 23 that is closed at the bottom. The ferromagnetic housing 23 is closed with a ferromagnetic end disc 25 above which a coil bobbin 26 made of non-ferromagnetic material is arranged. The coil bobbin 26 has an energizable voice coil. Energizing leads are not shown in the drawing. The arrangement is built into a tubular guiding element, for instance a housing, also not shown. The coil bobbin 26 can be regarded as a second magnetic element capable of undergoing linear, vertical-direction displacement relative to the magnetic core 24 (operating as a pemanent or energized magnet) that acts as a first magnetic element. The primary role of the ferromagnetic housing 23 and the ferromagnetic end disc 25 is to increase magnetic flux. The displacement of the coil bobbin 26 relative to the ferromagnetic housing 23 is governed by the energization level of the electromagnetically energizable element of the coil bobbin 26. It should be mentioned here that the objective of the invention is to provide that this displacement may be halted at a certain arbitrary position or moment of time in such a manner that a static pressing force remains there without energization. In case energization is switched off, a static pressing force could not be provided by magnetic means in an arbitrary position—since the coil bobbin 26 does not contain a permanent magnet this is not possible anyway. Therefore another physical effect must be utilized to provide the necessary static pressing force. For instance, an air-containing enclosure applied as an air spring may be utilized. This is illustrated in FIG. 3 (above) showing an air valve built into the upper end of the coil bobbin 26. The valve may be implemented with a cap 27 having openings that may be closed by means of a rotatable closing member such as a plate or a “butterfly” disc 28. The closing member may be rotated magnetically, or utilizing a relay or motor, etc. When the coil bobbin 26 submerges into the ferrofluid that partially fills the interior of the guiding element (not shown), an enclosed (or encloseable) air region, acting as a spring, is produced at the upper part of the coil bobbin 26.

FIG. 4 shows a possible arrangement of controlling a system in which a small actuator 35 is used for lifting a relatively big load 38. Digital controlling means, in this example a PC 31 through a microcontroller 32 provide control signal. The microcontroller 32 converts the control signal, for example a PCM signal, to PWM signal. The driving signal for the valve 36 of the actuator 35 is generated by a PWM amplifier 33 and a controlled switch 34. The driving signal can be a multi-voltage level PWM signal and used for driving the actuator 35 according to any of the previously mentioned kinds through its valve 36. The second magnetic element 37 of the actuator 35 can be controlled to move periodically, step by step upwards. In this way the upper bearing surface of the second magnetic element 37 can lift significantly heavier load 38 than the known actuators or similar means of the same size. The lifting movement may require more time, however it may still represent a significant advantage by the smaller size.

The actuators heretofore discussed are preferably operated by a computer, which may be a personal computer with a USB data link, or a special purpose-made computer device. The actuator may be driven by electric means, where “driving” includes the energization of the first and second magnetic elements. The first magnetic element may be a permanent magnet, in which case electric energization is not necessary. The latching means may accordingly be driven by a valve control switch or a brake switch that are also controlled by a computer or micro-controller, either in an arrangement different from that of shown in FIG. 4 for example.

A suitable resilient member, such as a spider or a resilient membrane, may be applied for providing a restoring force to the second magnetic element of the actuator, the resilient member also allowing the embedding of the actuator in a flat-surface element, in which arrangement the actuator (more specifically the portion of the actuator protruding from the flat surface) is capable of applying force on an object or person touching the surface.

This leads to two characteristic ways of utilizing the inventive actuator. The first of these is in an active vest applied as an accessory for computer games and other interactive software such as simulations. FIG. 5 shows the schematic view of the configuration of such an active vest. The “skeleton” of the vest, providing mechanical support, is made up of a waist strap 51 and a spine rail 52, with slide straps 54 being attached thereto by sliders 53. As it is shown in the drawing, the identical slide straps 54 are connected to one another such that a spring dynamometer 56 is disposed between their respective ends. The elastic-rigid spine rail 52 and the waist strap 51 attached to the bottom portion thereof form a vest-like device that may be secured to the waist and back regions of the user's body. The present description concerns only the functional “skeleton” of the vest, without referring to other non-functional elements included e.g. for improving aesthetic appearance. The slide straps 54 are preferably made of fabric or other high-tensile strength material. Utilizing the sliders 53 the slide straps 54 are freely movable along the spine rail 52. The length of the slide straps 54 is preferably chosen such that the assembly of the spring dynamometer 56 and dynamometer attachment buckle 57 may be adjusted in a wide range to fit to the chest of users of different body sizes. Actuators 55 are disposed on the slide straps 54 in a manner that they are freely movable along the slide straps 54 and the pressing surface of the actuators faces the user. With the help of the spring dynamometer 56—dynamometer attachment buckle 57 assemblies the user may adjust the strength with which individual actuators 55 are pressed against the body, and thereby may adjust the maximum value of the pressing force each actuator 55 exerts on the user. The operation of the actuators 55 is controlled via a wired or wireless connection in a manner not shown in the drawing. The actuators 55 are ordered by a computer program to exert time- and space-variable mechanical action on the user. The active vest discussed above may be applied for inducing tactile, pressure and gravitational sensations in the user, primarily in virtual environments where these sensations are complemented by audiovisual effects.

A further specific field of application of the invention is an active seat. Similarly to the above described active vest, the active seat receives control orders from a computer that also provides the complementary audiovisual effects. An exemplary schematic view of the active seat is shown in FIG. 6. The seat 63 is movably disposed on a stationary pedestal 62. The actuators 61, applied for providing active support of the pedestal 62 and seat 63 are disposed at the corners of the pedestal 62. Of course, more than three actuators 61 may also be applied, e.g. together with a rectangular pedestal. The actuators 61 are capable of producing both stationary and pulsating force, providing that the user seated in the seat 63 may experience different virtual sensations of gravitational effects, impacts, etc.

The actuator arrangement according to the invention may also be utilized in erotic devices such as devices producing vibratory or pressure force effects, with or without computer control.

The inventive actuator specified in the present description may thus be advantageously applied in several devices for producing mechanical effects.

The actuator arrangement according to the invention may also be useful where heavy loads are to be moved, lifted by small size actuator means and the high speed of such movement is not required.

1. Electromagnetically operated mechanical actuator comprising:
a stationary first magnetic element (4,14) applied for generating magnetic field,
a second magnetic element (8,18) arranged movably relative to the first magnetic element, the second magnetic element (8,18) consisting of a supporting element fitted with an electromagnetic energizing element,
a guiding element providing that the second magnetic element may be moved along a given linear path relative to the first magnetic element (4,14),
a ferrofluid (3,3a) disposed in the interior of the guiding element such that it surrounds, at least partially, the supporting element, and
a sealed gas-filled region communicating with the ferrofluid,
characterised in that it has electrically controlled latching means adapted for stopping and securing the second magnetic element (8) in an arbitrary linear displacement position relative to the first magnetic element (4), where the latching means is an electrically controlled valve (7, 17) adapted for allowing or stopping gas flow in the gas-filled region.

2. The actuator according to claim 1, characterised in that the supporting element is a coil bobbin (6) having an open and a closed end, with the open end submerging into the ferrofluid (3); and the latching means is a valve (7) disposed at the closed end of the coil bobbin (6).

3. The actuator according to claim 1, characterised in that the supporting element is a coil bobbin (16) submerging into the ferrofluid in its entirety, the coil bobbin (16) being attached at one end to a piston (19), where the guiding element is a piston cylinder paving a sealed gas- or liqiud-filled region divided into two gas- or liqiud-filled sub-regions (12, 13) connected through a flow-through conduit (21), and where the latching means is implemented as a controlled valve (17) adapted for allowing or stopping the flow through the flow-through conduit (21) of the gas- or liqiud contained in the gas- or liqiud-filled region.

4. Active vest comprising a waist strap adapted for being strapped around the back and waist regions of a user, a spine rail, and slide straps, with electromechanical actuators (55) being disposed on the slide straps, characterised by that the actuators (55) are implemented as the actuators according to any one of claims 1-3.

5. Active seat consisting of a seat disposed on a horizontal pedestal and of mechanical actuators (61) adapted for supporting the pedestal, characterised by that the actuators (61) are implemented as the actuators according to any one of claims 1-3.
